(19) United States
(12) Patent Application Publication
(10) Pub. No.: US 2018/0202500 A1
(43) Pub. Date: Jul. 19, 2018

(54) CLUTCH DEVICE AND POWER TRANSMISSION DEVICE

(71) Applicant: AISIN AW CO., LTD., Anjo-shi, Aichi-ken (JP)

(72) Inventors: Masanori MURAKAMI, Toyota (JP); Shota IKEDA, Okazaki (JP); Tomohiro NISHINA, Nishio (JP); Tsubasa TAMURA, Anjo (JP)

(73) Assignee: AISIN AW CO., LTD., Anjo-shi, Aichi-ken (JP)

(21) Appl. No.: 15/743,862

(22) PCT Filed: Sep. 27, 2016
(86) PCT No.: PCT/JP2016/078412

§ 371 Date: Jan. 11, 2018

(30) Foreign Application Priority Data
Sep. 29, 2015 (JP) 2015-191458

(51) Int. Cl. F16D 25/0638; F16D 25/12; F16D 21/06; F16D 13/70; F16H 63/30; F16D 3/18; F16D 13/64

(52) U.S. Cl. CPC F16D 25/0638; F16D 25/12; F16D 21/06; F16D 13/70; F16D 2021/0661; F16D 3/18; F16D 13/644; F16D 2500/50293; F16H 63/3026

(57) ABSTRACT

Protruding portions have an agitation face on the side surface thereof to agitate or dam hydraulic oil. An oil chamber defining portion has a supply hole that is allowed to supply the hydraulic oil from outside a hydraulic oil chamber by communicating with the hydraulic oil chamber from the rotational center side. When the protruding portions abut against the oil chamber defining portion so that the capacity of the hydraulic oil chamber is minimized, the supply hole faces, in a radial direction, a flow passage that is surrounded by circumferentially adjacent ones of the protruding portions, an oil chamber defining portion, and a piston.

### TECHNICAL FIELD

The present disclosure relates to a clutch device and a power transmission device suitable for use in transmissions mounted on, for example, vehicles.

### BACKGROUND ART

Automatic transmissions, for example, having a multi-speed changer commonly employ a friction engagement device (hereinafter, referred to collectively as a clutch device) that includes a multi-plate clutch and a multi-plate brake to establish multiple shift speeds by oil pressure supplied thereto and discharged therefrom. One known clutch device includes: a piston for pressing and engaging multiple friction plates; a hydraulic oil chamber for supplying the piston with oil pressure that forces the piston to slide toward the friction plates (toward the direction of engagement); and a cancel oil chamber that is located axially opposite the hydraulic oil chamber across the piston (refer to Patent Document 1).

In this type of clutch device, oil pressure in a hydraulic oil chamber that stores hydraulic oil becomes higher on the outer periphery, i.e., centrifugal oil pressure is generated. After the centrifugal oil pressure is generated, the effective pressure of oil pressure supplied to the piston changes depending on the rotational speed, and consequently controllability may be degraded. To curb the generation of centrifugal oil pressure, centrifugal oil pressure is generated also in the cancel oil Chamber so that the centrifugal oil pressures in the hydraulic oil chamber and the cancel oil chamber face each other across the piston so as to cancel each other out.

### RELATED ART DOCUMENTS

### Patent Documents

Patent Document 1: Japanese Patent Application Publication No. 2015-68443 (JP 2015-68443 A)

### SUMMARY

### Problem to be Solved

However, the clutch device described above still takes no account of the speed of flow of hydraulic oil in the hydraulic oil chamber. Therefore, the following problems may be caused.

Hydraulic oil in the hydraulic oil chamber flows on the outside diameter side and on the inside diameter side at different circumferential speeds (rotational speeds) corresponding to their respective diameters, and the circumferential speed is lower on the inside diameter side. During an engagement transition where hydraulic oil is supplied to the hydraulic oil chamber so as to slide the piston toward the direction of engagement, as much hydraulic oil as the amount of hydraulic oil to be supplied (as the amount of space in the hydraulic oil chamber) flows inside the hydraulic oil chamber from the inside diameter side, on which the circumferential speed is lower, toward the outside diameter side, on which the circumferential speed is higher. If the hydraulic oil is not accelerated enough to reach the circumferential speed of the hydraulic oil chamber at this time, the circumferential speed of the hydraulic oil becomes lower than the circumferential speed of the piston and the hydraulic oil chamber. An expected value of centrifugal oil pressure generated by the hydraulic oil is set on the assumption that the circumferential speed of the hydraulic oil is almost equal to the circumferential speed of the hydraulic oil chamber. Therefore, if the circumferential speed of the hydraulic oil becomes lower than the circumferential speed of the hydraulic oil chamber, centrifugal oil pressure actually generated by the hydraulic oil may become smaller than the expected value.

Further, as in the case described above, hydraulic oil in the cancel oil chamber flows at circumferential speeds corresponding to the diameters thereof, and the circumferential speed is lower on the inside diameter side. During the engagement transition, centrifugal oil pressure in the cancel oil chamber becomes almost equal to an estimated value thereof because hydraulic oil is not supplied in the same manner as in the hydraulic oil chamber, whereas the centrifugal oil pressure in the hydraulic oil chamber becomes smaller than the expected value. This may cause the piston during the engagement transition to fall into an overcancel state where the centrifugal oil pressure in the cancel oil chamber exceeds the centrifugal oil pressure in the hydraulic oil chamber.

The overcancel state degrades the responsiveness of engagement and disengagement of the clutch device, thus degrading the controllability.

Therefore, the purpose is to provide a clutch device and a power transmission device that reduce a difference in circumferential speed between hydraulic oil and a hydraulic oil chamber during a transition between engagement and disengagement, thereby improving responsiveness and achieving satisfactory controllability.

### Means for Solving the Problem

A clutch device according to the present disclosure includes: a hydraulic servo including a piston, an oil chamber defining portion that rotates along with the piston, that supports the piston movably in an axial direction, and that forms together with the piston a variable capacity hydraulic oil chamber between the piston and the oil chamber defining portion, and a cancel plate portion that faces the oil chamber defining portion across the piston in the axial direction and that forms together with the piston a variable capacity cancel oil chamber between the piston and the cancel plate portion; multiple friction plates to be engaged by being pressed by the piston that moves in the axial direction in accordance with hydraulic oil supplied to the hydraulic oil chamber; and protruding portions that are formed at at least one of a facing portion of the oil chamber defining portion and a facing portion of the piston and that protrude in the axial direction toward the other of the facing portions, in which the protruding portions have an agitation face on its side surface to agitate or dam the hydraulic oil, the oil chamber defining portion has a supply hole that is allowed to supply the hydraulic oil from outside the hydraulic oil chamber by communicating with the hydraulic oil chamber from the rotational center side, and when the protruding portions abut against the other of the facing portions so that the capacity of the hydraulic oil chamber is minimized, the supply hole faces, in a radial direction, a flow passage that is surrounded by circumferentially adjacent ones of the protruding portions and the facing portions.

Further, a clutch device according to the present disclosure includes: a hydraulic servo including a piston, an oil chamber defining portion that rotates along with the piston, that supports the piston movably in an axial direction, and that forms together with the piston a variable capacity hydraulic oil chamber between the piston and the oil chamber defining portion, and a cancel plate portion that faces the oil chamber defining portion across the piston in the axial direction and that forms together with the piston a variable capacity cancel oil chamber between the piston and the cancel plate portion; a plurality of friction plates to be engaged by being pressed by the piston that moves in the axial direction in accordance with hydraulic oil supplied to the hydraulic oil chamber; and protruding portions that are formed at at least one of a facing portion of the oil chamber defining portion and a facing portion of the piston and that protrude in the axial direction toward the other of the facing portions, in which the protruding portions have an agitation face on its side surface to agitate or dam the hydraulic oil, and the agitation face has a flat or concave surface extending in a direction crossing a circumferential direction.

### Effects

Since the clutch device has the agitation face for agitating or damming the hydraulic oil, the hydraulic oil in the hydraulic oil chamber is agitated or dammed by the agitation face during rotation of the piston and the oil chamber defining portion so that the circumferential speed of the hydraulic oil becomes equal to the circumferential speed of the piston and the oil chamber defining portion. This reduces the circumferential speed difference between the hydraulic oil and the hydraulic oil chamber even during a transition between engagement and disengagement of the clutch device, thus stabilizing the cancel performance, improving the responsiveness, and achieving satisfactory controllability.

### BRIEF DESCRIPTION OF THE DRAWINGS

FIG. 1 is a skeleton diagram schematically illustrating an automatic transmission according to an embodiment.

FIG. 2 is an engagement table for engagement elements of the automatic transmission according to the embodiment.

FIG. 3 is a speed diagram of the automatic transmission according to the embodiment.

is a sectional view schematically illustrating a part, including a second clutch, of the automatic transmission according to the embodiment.

FIG. 5A is a perspective view of a piston of the second clutch according to the embodiment.

FIG. 5B is a front view of the piston of the second clutch according to the embodiment.

FIG. 6A is a perspective view of a piston of a second clutch according to another embodiment.

FIG. 6B is a front view of a protruding portion of a piston of a second clutch according to still another embodiment.

FIG. 7A is a perspective view of a piston according to a comparative example.

FIG. 7B is a diagram showing a comparison result of dynamic pressure loss.

### BEST MODE

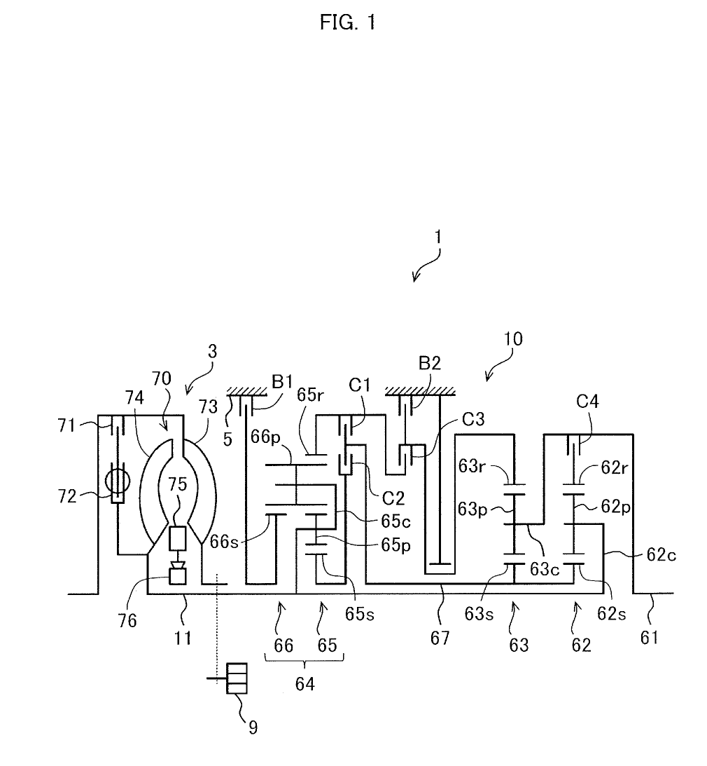

Below, the present embodiment is described with reference to FIG. 1 to FIG. 7B. According to the present embodiment, a clutch device is used in a power transmission device 1 of a vehicle, and the power transmission device 1 includes an automatic transmission 10. However, the power transmission device 1 is not limited to this and may be used, for example, as a vehicle drive device suitable for use in hybrid vehicles that use multiple drive sources. The clutch device is not limited to this use and can be used widely as a clutch device that connects and disconnects a power transmission path for transmitting a rotational force.

First, the schematic structure of the power transmission device 1 according to the present embodiment is described with reference to FIG. 1 to FIG. 3. The power transmission device I according to the present embodiment is connected to a crankshaft of a non-illustrated internal combustion engine longitudinally mounted at the front of a rear-wheel drive vehicle to transmit power from the engine to non-illustrated right and left rear wheels. The power transmission device 1 includes: a starting device 3; an oil pump 9; the automatic transmission (a speed change mechanism) 10 that changes the speed of power transmitted from the internal combustion engine to an input shaft (an input member) 11 and that transmits the power to an output shaft (an output member) 61; and a transmission case 5 that houses these components. The automatic transmission 10 according to the present embodiment includes, for example, a multi-speed change mechanism that is interposed between the non-illustrated internal combustion engine and the non-illustrated wheels to establish multiple switchable shift speeds by engaging and disengaging multiple clutches and brakes. Further, according to the present embodiment, the automatic transmission 10 is of a front-engine, rear-wheel drive type. In FIG. 1 and FIG. 4, the left side represents the front where the internal combustion engine is mounted, and the right side represents the rear where the output shaft is mounted.

The starting device 3 includes: a torque converter 70; a lock-up clutch 71 for connecting and disconnecting a front cover coupled to the crankshaft of the internal combustion to and from the input shaft 11 of the automatic transmission 10; and a damper mechanism 72 for dampening vibrations between the front cover and the input shaft 11 of the automatic transmission 10. The torque converter 70 includes: an input-side pump impeller 73 coupled to the front cover; an output-side turbine runner 74 coupled to the input shaft 11 of the automatic transmission 10; a stator 75 located inside the pump impeller 73 and the turbine runner 74 to straighten the flow of hydraulic oil from the turbine runner 74 to the pump impeller 73; and a one-way clutch 76 that is supported by a non-illustrated stator shaft and that restricts rotation of the stator 75 to one direction. Alternatively, the torque converter 70 may be a fluid coupling that does not have the stator 75.

The oil pump 9 is structured as a gear pump that includes: a pump assembly having a pump body and a pump cover; an external gear coupled to the pump impeller 73 of the torque converter 70 via a chain or a gear train; and an internal gear that meshes with the external gear. The oil pump 9 is driven by power from the engine, thus sucking hydraulic oil (ATF) reserved in a non-illustrated oil pan and pumping the hydraulic oil to a hydraulic control device.

The automatic transmission 10 is structured as a 10-speed transmission and has a shifting gear mechanism that includes: the input shaft 11; the output shaft 61 coupled to the right and left rear wheels via a non-illustrated differential gear and non-illustrated drive shafts; a first planetary gear set 62 and a second planetary gear set 63 that are each a single-pinion planetary gear set and that are arranged side by side in the axial direction of the input shaft 11 and the output shaft 61; and a Ravigneaux planetary gear mechanism 64 as a compound planetary gear mechanism that is structured as a combination of a double-pinion planetary gear set and a single-pinion planetary gear set. Further, the automatic transmission 10 includes six friction engagement elements for changing a power transmission path from the input shaft 11 to the output shaft 61, namely a first clutch C1, a second clutch C2, a third clutch C3, a fourth clutch C4, a first brake B1, and a second brake B2.

According to the present embodiment, the first and second planetary gear sets 62 and 63 and the Ravigneaux planetary gear mechanism 64 are located inside the transmission case 5 and are arranged in the following order starting from the starting device 3 side, i.e., the internal combustion engine side (the left side in FIG. 1): the Ravigneaux planetary gear mechanism 64, the second planetary gear set 63, and the first planetary gear set 62. Thus, the Ravigneaux planetary gear mechanism 64 is located at the front of the vehicle so as to be close to the starting device 3, the first planetary gear set 62 is located at the rear of the vehicle so as to be close to the output shaft 61, and the second planetary gear set 63 is located between the Ravigneaux planetary gear mechanism 64 and the first planetary gear set 62.

The first planetary gear set 62 includes: a first sun gear 62s that is an external gear; a first ring gear 62r that is an internal gear concentric with the first sun gear 62s; multiple first pinion gears 62p that each mesh with the first sun gear 62s and the first ring gear 62r; and a first carrier 62c that rotatably (spinably) supports the multiple first pinion gears 62p. According to the present embodiment, a gear ratio λ1 (the number of teeth of the first sun gear 62s/the number of teeth of the first ring gear 62r) is set to, for example, 0.277.

The first carrier 62c of the first planetary gear set 62 is continuously coupled (fixed) to the input shaft 11. Thus, while power is transmitted from the internal combustion engine to the input shaft 11, the power from the internal combustion engine is continuously transmitted to the first carrier 62c via the input shaft 11. The first carrier 62c serves as an input element of the first planetary gear set 62, and the first ring gear 62r serves as an output element of the first planetary gear set 62 when the fourth clutch C4 is engaged.

The second planetary gear set 63 includes: a second sun gear 63s that is an external gear; a second ring gear 63r that is an internal gear concentric with the second sun gear 63s; multiple second pinion gears 63p that each mesh with the second sun gear 63s and the second ring gear 63r; and a second carrier 63c that rotatably (spinably) supports the multiple second pinion gears 63p. According to the present embodiment, a gear ratio λ2 (the number of teeth of the second sun gear 63s/the number of teeth of the second ring gear 63r) is set to, for example, 0.244.

The second sun gear 63s of the second planetary gear set 63 is integrated with (continuously coupled to) the first sun gear 62s of the first planetary gear set 62 so as to stop or rotate always along with (and concentrically with) the first sun gear 62s. Alternatively, the first sun gear 62s and the second sun gear 63s may be formed as separate pieces and continuously coupled to each other via a non-illustrated coupling member. The second carrier 63c of the second planetary gear set 63 is continuously coupled to the output shaft 61 so as to stop or rotate always along with (and concentrically with) the output shaft 61. Thus, the second carrier 63c serves as an output element of the second planetary gear set 63. Further, the second ring gear 63r of the second planetary gear set 63 can be held stationary by the second brake B2 and thus can serve as a stationary element of the second planetary gear set 63.

The Ravigneaux planetary gear mechanism 64 is a compound planetary gear mechanism structured as a combination of a third planetary gear set 65 that is a double-pinion planetary gear set and a fourth planetary gear set 66 that is a single-pinion planetary gear set. Specifically, the planetary gear sets are arranged inside the transmission case 5 in the following order starting from the internal combustion engine side: the fourth planetary gear set 66, the third planetary gear set 65, the second planetary gear set 63, and the first planetary gear set 62.

The Ravigneaux planetary gear mechanism 64 includes: a third sun gear 65s and a fourth sun gear 66s that are each an external gear; a third ring gear 65r that is an internal gear concentric with the third and fourth sun gears 65s and 66s; multiple third pinion gears (short pinion gears) 65p that mesh with the third sun gear 65s; multiple fourth pinion gears (long pinion gears) 66p that mesh with the fourth sun gear 66s, the multiple third pinion gears 65p, and the third ring gear 65r; and a third carrier 65c that rotatably (spinably) supports the multiple third pinion gears 65p and the multiple fourth pinion gears 66p.

The third planetary gear set 65 is structured with the third sun gear 65s, the third carrier 65c, the third pinion gears 65p, the fourth pinion gears 66p, and the third ring gear 65r. The fourth planetary gear set 66 is structured with the fourth sun gear 66s, the third carrier 65c, the fourth pinion gears 66p, and the third ring gear 65r. According to the present embodiment, the Ravigneaux planetary gear mechanism 64 is structured such that a gear ratio λ3 (the number of teeth of the third sun gear 65s/the number of teeth of the third ring gear 65r) is, for example, 0.488 and such that a gear ratio λ4 (the number of teeth of the fourth sun gear 66s/the number of teeth of the third ring gear 65r) is, for example, 0.581.

Out of the rotating elements of the Ravigneaux planetary gear mechanism 64, the fourth sun gear 66s can be held stationary by the first brake B1 and thus can serve as a stationary element of the Ravigneaux planetary gear mechanism 64. The third carrier 65c is continuously coupled (fixed) to the input shaft 11 and is also continuously coupled to the first carrier 62c of the first planetary gear set 62. Thus, while power is transmitted from the internal combustion engine to the input shaft 11, the power from the internal combustion engine is continuously transmitted to the third carrier 65c via the input shaft 11. Thus, the third carrier 65c serves as an input element of the

Ravigneaux planetary gear mechanism 64. The third ring gear 65r is coupleable with the sun gear 63s of the second planetary gear set 63 and the sun gear 62s of the first planetary gear set 62 via the first clutch C2 and an intermediate shaft 67 and is coupleable with the ring gear 63r of the second planetary gear set 63 via the third clutch C3, thus serving as a first output element of the Ravigneaux planetary gear mechanism 64. The third sun gear 65s is coupleable with the sun gear 63s of the second planetary gear set 63 and the sun gear 62s of the first planetary gear set 62 via the second clutch C2 and the intermediate shaft 67, thus serving as a second output element of the Ravigneaux planetary gear mechanism 64.

The first clutch C1 connects and disconnects, to and from the third ring gear 65r of the Ravigneaux planetary gear mechanism 64, the first sun gear 62s of the first planetary gear set 62 and the second sun gear 63s of the second planetary gear set 63 that are continuously coupled together. The second clutch C2 connects and disconnects, to and from the third sun gear 65s of the Ravigneaux planetary gear mechanism 64, the first sun gear 62s of the first planetary gear set 62 and the second sun gear 63s of the second planetary gear set 63 that are continuously coupled together. The third clutch C3 connects and disconnects the second ring gear 63r of the second planetary gear set 63 to and from the third ring gear 65r of the Ravigneaux planetary gear mechanism 64. The fourth clutch C4 connects and disconnects the first ring gear 62r of the first planetary gear set 62 to and from the output shah 61.

The first brake B1 causes the fourth sun gear 66s of the Ravigneaux planetary gear mechanism 64 to be held stationary (connected) with respect to the transmission case 5 so as to stop the fourth sun gear 66s from rotating and releases the fourth sun gear 66s from the transmission case 5 so as to allow the fourth sun gear 66s to be free to rotate. The second brake B2 causes the second ring gear 63r of the second planetary gear set 63 to be held stationary (connected) with respect to the transmission case 5 so as to stop the second ring gear 63r from rotating and releases the second ring gear 63r from the transmission case 5 so as to allow the second ring gear 63r to be free to rotate.

According to the present embodiment, each of the first clutch C1 to the fourth clutch C4 is a multi-plate hydraulic friction clutch having a hydraulic servo that includes: a piston; multiple friction engagement plates (for example, a friction plate that is an annular member with sides covered with bonded friction materials, and a separator plate that is an annular member with smoothed sides); and an engagement oil chamber and a centrifugal oil pressure cancellation chamber that are each supplied with hydraulic oil. On the other hand, each of the first brake B1 and the second brake B2 is a multi-plate hydraulic friction brake having a hydraulic servo that includes: a piston; multiple friction engagement plates (a friction plate and a separator plate); and an engagement oil chamber that is supplied with hydraulic oil.

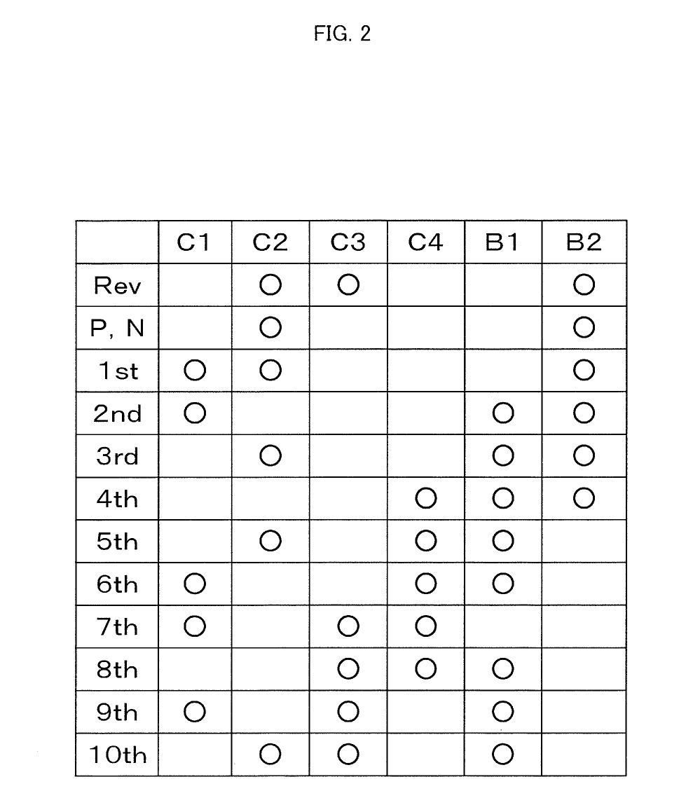

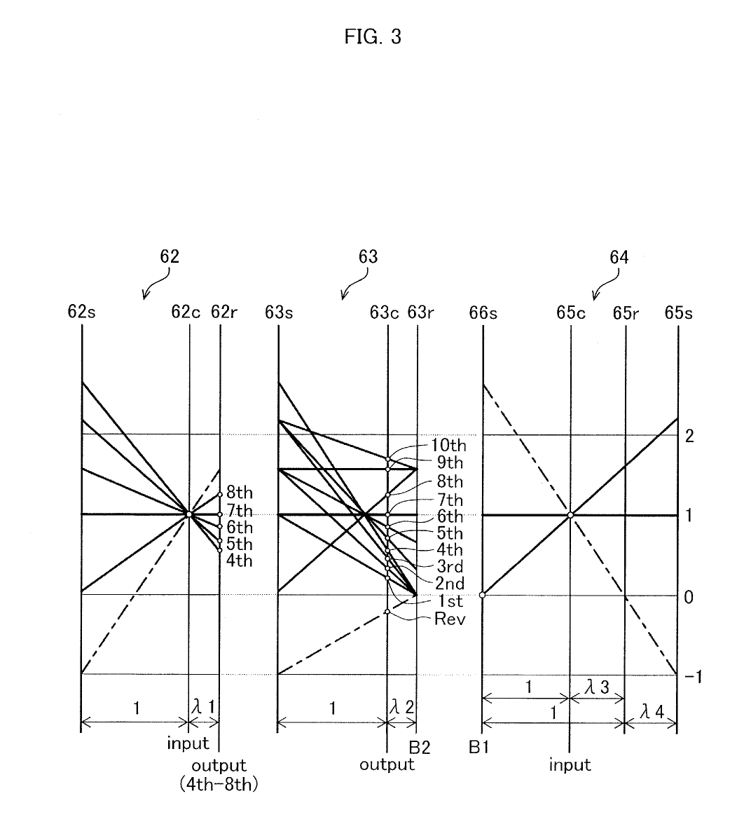

FIG. 2 is an engagement table illustrating the relationship between each shift speed of the automatic transmission 10 and corresponding operating states of the first clutch C1 to the fourth clutch C4, the first brake B1, and the second brake B2. FIG. 3 is a speed diagram illustrating the ratio of the rotational speed of each of the rotating elements relative to the rotational speed of the input shaft 11 in the automatic transmission 10 (assuming that the rotational speed of the input shaft 11, i.e., the first carrier 62c and the third carrier 65c has a value of one). In the automatic transmission 10 structured in a manner described above, when the first clutch C1 to the fourth clutch C4, the first brake B1, and the second brake B2 are engaged and disengaged according to combinations shown in the engagement table of FIG. 2, a first forward speed (1st) to a tenth forward speed (10th) and a first reverse speed (Rev) are established at rotational speed ratios shown in the speed diagram of FIG. 3.

As illustrated in FIG. 4, the automatic transmission 10 includes the input shaft 11, the first clutch C1, the second clutch (a clutch device) C2, and the Ravigneaux planetary gear mechanism 64. The Ravigneaux planetary gear mechanism 64, the second clutch C2, and the first clutch C1 are arranged adjacently in the axial direction from the front to the rear.

The second clutch C2 includes a hydraulic servo 20 and multiple friction plates, namely, inner friction plates 30 and outer friction plates 31. The hydraulic servo 20 includes a piston 40, an oil chamber defining portion 22, a cancel plate portion 23, and a return spring 27. Further, the second clutch C2 includes a clutch drum 24 that supports the inner friction plates 30, and a drum member 25 that supports the outer friction plates 31. Specifically, the hydraulic servo 20 is disposed between the clutch. drum 24 and the drum member 25.

The clutch drum 24 includes an annular wall portion 24a having a substantially annular shape and a cylindrical hub portion 24b extending rearward from an outer peripheral portion of the annular wall portion 24a. An inner peripheral portion of the annular wall portion 24a is supported via a spline on an outer peripheral portion of a later-described sleeve portion 22a of the oil chamber defining portion 22. Further, a front part of the annular wall portion 24a is spline-coupled to the sun gear 65s of the Ravigneaux planetary gear mechanism 64. The multiple inner friction plates 30 are mounted via a spline on an outer peripheral portion of the hub portion 24b.

The drum member 25 includes an annular portion 25a having a substantially annular shape and a cylindrical drum portion 25b extending forward from an outer peripheral portion of the annular portion 25a. An inner peripheral portion of the annular portion 25a is welded to a coupling member 26, and the drum member 25 is rotatably supported with respect to the input shaft 11 by the coupling member 26. The multiple outer friction plates 31 are mounted via a spline on an inner peripheral portion of the drum portion 25b. Specifically, the drum portion 25b is shaped so as to extend rearward beyond the annular portion 25a, and the first clutch C1 is mounted on an outer peripheral portion of the drum portion 25b. Thus, the drum member 25 serves as a clutch hub of the first clutch C1 and as a clutch drum of the second clutch C2.

The oil Chamber defining portion (the other of facing portions) 22 includes the sleeve portion 22a rotatably supported by the input shaft 11 and a flange portion 22b shaped so as to extend radially outward from the rear end of the sleeve portion 22a. The oil chamber defining portion 22 supports the piston 40 movably in the axial direction and forms together with the piston 40 a variable capacity hydraulic oil chamber 50 therebetween. The sleeve portion 22a has supply holes 22c formed in the vicinity of the flange portion 22b. For example, eight supply holes 22c are formed at regular intervals in a circumferential direction. Specifically, the input shaft 11 has a communication hole 11a for supplying hydraulic oil from inside to outside the input shaft 11, and the supply holes 22c of the sleeve portion 22a are located so as to face the communication hole 11a in accordance with rotation. This allows the oil chamber defining portion 22 to supply the hydraulic oil from outside the hydraulic oil chamber 50 by communicating with the hydraulic oil chamber 50 from the rotational center side.

The piston 40 includes a pressure receiving portion (one of facing portions) 41 having a substantially annular shape, a cylindrical potion 42 shaped to extend rearward. from an outer peripheral portion of the pressure receiving portion 41, and a pressing portion 43 shaped to protrude forward and radially outward from the rear end of the cylindrical potion 42. An inner peripheral portion of the pressure receiving portion 41 is slidably supported by the outer peripheral portion of the sleeve portion 22a of the oil chamber defining portion 22. An inner peripheral portion of the cylindrical potion 42 is slidably supported by an outer peripheral portion of the flange portion 22b of the oil chamber defining portion 22. A spring hole 45 that houses the return spring 27 is formed in the front surface of the pressure receiving portion 41.

The pressing portion 43 of the piston 40 engages the inner friction plates 30 and the outer friction plates 31 with each other by pressing the inner friction plates 30 and the outer friction plates 31 in the axial direction. Specifically, the inner friction plates 30 and the outer friction plates 31 are engaged with each other by being pressed by the piston 40 that moves in the axial direction in accordance with hydraulic oil supplied to the hydraulic oil chamber 50.

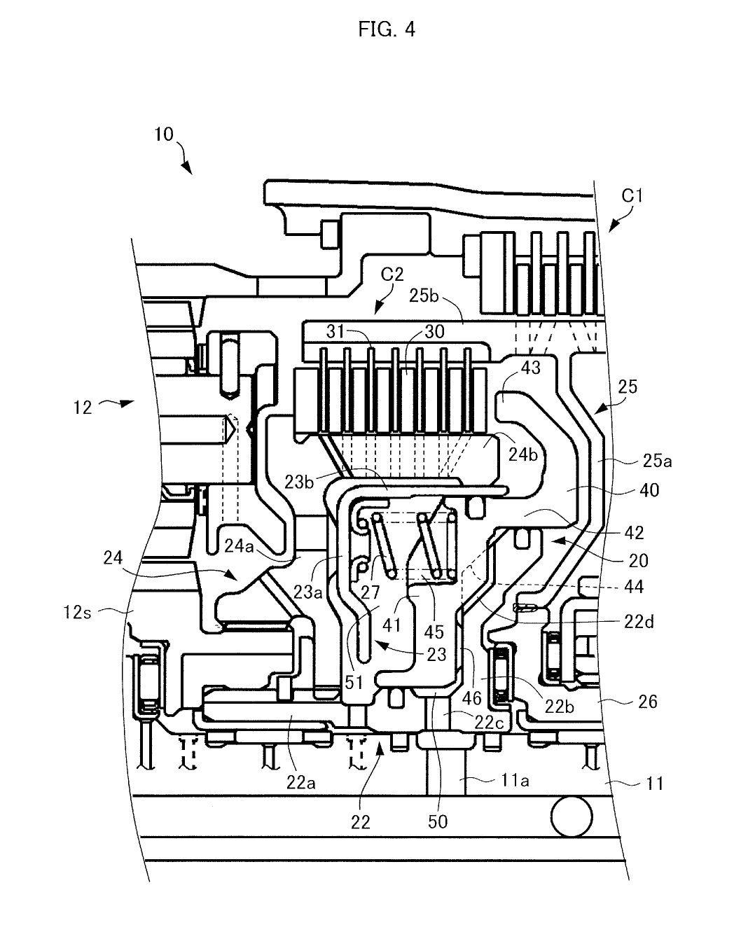

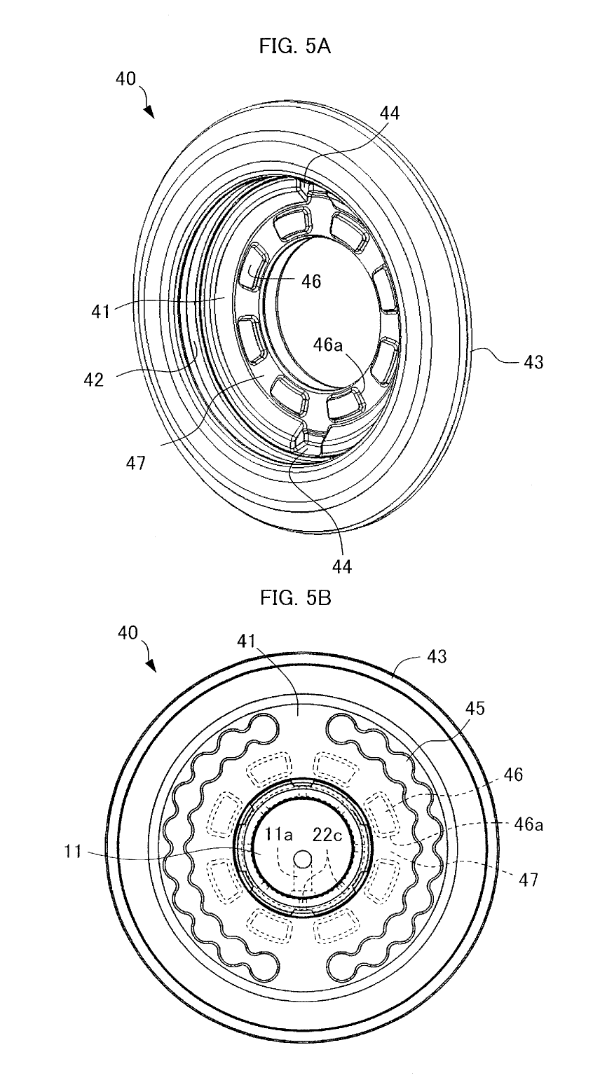

A projection 22d shaped to project forward is formed in the vicinity of an outer peripheral portion of the front surface of the flange portion 22b of the oil chamber defining portion 22. Further, a recess 44 is formed in the vicinity of an outer peripheral portion of the rear surface of the pressure receiving portion 41 of the piston 40. The projection 22d engages with the recess 44, thereby forming a rotation stopper for preventing relative rotation between the piston 40 and the oil chamber defining portion 22. According to the present embodiment, two projections 22d are arranged at different positions that are evenly spaced in the circumferential direction, i.e., arranged at phase intervals of 180 degrees, and two recesses 44 are arranged at different positions that are evenly spaced in the circumferential direction, i.e., arranged at phase intervals of 180 degrees (refer to FIG. 5A). However, the projections 22d and the recesses 44 are not limited to this arrangement and may be arranged at three or more positions.

The hydraulic oil chamber 50 is a space defined by the sleeve portion 22a and the flange portion 22b of the oil chamber defining portion 22, and the pressure receiving portion 41 and the cylindrical potion 42 of the piston 40. When oil pressure is supplied to the hydraulic oil chamber 50 from the communication hole 11a of the input shaft 11 through the supply holes 22c of the oil chamber defining portion 22, the piston 40 slides forward, thus pressing and engaging the inner friction plates 30 and the outer friction plates 31.

The cancel plate portion 23 is supported on the inner periphery of the hub portion 24b of the clutch drum 24 and includes: an annular portion 23a having a substantially annular shape; and a cylindrical portion 23b shaped to extend rearward from an outer peripheral portion of the annular portion 23a. An outer peripheral portion of the cylindrical portion 23b is supported by an inner peripheral portion of the hub portion 24b of the clutch drum 24. The cancel plate portion 23 faces the flange portion 22b of the oil chamber defining portion 22 across the pressure receiving portion 41 of the piston. 40 in the axial direction and forms together with the pressure receiving portion 41 a variable capacity cancel oil chamber 51 therebetween.

The return spring 27 has multiple compression coil springs, is supported at the rear end thereof by the spring hole 45 in the pressure receiving portion 41 of the piston 40, and is supported at the front end thereof by the annular portion 23a of the cancel plate portion 23. Thus, the return spring 27 is held between the spring hole 45 and the annular portion 23a. The return spring 27 is biased in a direction that separates the piston 40 and the cancel plate portion 23 away from each other. Thus, when the supply of oil pressure to the hydraulic oil chamber 50 is sufficiently reduced, the piston 40 slides rearward by the biasing force of the return spring 27 so that the inner friction plates 30 and the outer friction plates 31 are disengaged.

Next, the structure of the piston 40 is described in detail with reference to FIGS. 5A and 5B. Protruding portions 46 are formed on the rear surface of the pressure receiving portion 41 and protrude toward the flange portion 22b of the oil chamber defining portion 22 in the axial direction, Specifically, the protruding portions 46 are formed integrally with the piston 40. According to the present embodiment, each of the protruding portions 46 is abuttable against the flange portion 22b of the oil chamber defining portion 22. Further, according to the present embodiment, the protruding portions 46 are arranged at eight positions that are evenly spaced in the circumferential direction. The number of positions is not limited to eight and may be at least three or more. It is not essential that all the protruding portions 46 be abuttable against the flange portion 22b of the oil chamber defining portion 22. Some of the protruding portions 46 may protrude by an amount less than an amount by which the others of the protruding portions 46 project so as not to abut against the flange portion 22b. As the height of the protruding portions 46 increases, the protruding portions 46 have more influence on hydraulic oil. Nevertheless, the height of the protruding portions 46 may be set appropriately according to design.

Each of the protruding portions 46 has an agitation face 46a on the side surface thereof to agitate or darn hydraulic oil. Specifically, the agitation face 46a is shaped to extend in a direction crossing the circumferential direction. In this example, the agitation face 46a is on a radial line from the center of rotation and has a flat surface. Thus, since the agitation face 46a is perpendicular to the circumferential direction, hydraulic oil in the hydraulic oil chamber 50 is agitated or dammed by the agitation face 46a more effectively during rotation of the piston 40 and the oil chamber defining portion 22 so that the rotational speed (the circumferential speed) of the hydraulic oil becomes close to the rotational speed of the piston 40 and the oil chamber defining portion 22.

According to the present embodiment, each of the protruding portions 46 has the agitation face 46a on both sides in the circumferential direction. However, the protruding portions 46 are not limited to those having the agitation face 46a on both sides in the circumferential direction and may have the agitation face 46a on only one side. The flat agitation face 46a is not limited to that lying on the radial line from the center of rotation and may be parallel to the radial line or may cross the circumferential direction at a right angle or at other angles.

Flow passages 47 are formed by spaces that are surrounded by circumferentially adjacent ones of the protruding portions 46, the pressure receiving portion 41, and the flange portion 22b. Further, as illustrated in FIG. 5B, when the capacity of the hydraulic oil chamber 50 is minimized, the supply holes 22c in the oil chamber defining portion 22 face the flow passages 47 in the radial direction. it is noted that the time when the capacity of the hydraulic oil chamber 50 is minimized is the time when the protruding portions 46 abut against the other of facing portions, i.e., in this example, the oil chamber defining portion 22. Thus, when oil pressure is supplied to the hydraulic oil chamber 50 through the supply holes 22c in a situation where the capacity of the hydraulic oil chamber 50 is minimized, the oil pressure is supplied from the supply holes 22c to the flow passages 47 that face the supply holes 22c. Thus, the protruding portions 46 avoid blocking a passage where the oil pressure flows. This ensures the flow performance of the oil pressure so as not to cause an increase in pressure loss.

According to the present embodiment, the cross-sectional area of the flow passages 47 is set equal to the cross-sectional area of the supply holes 22c. The cross-sectional area of the flow passages 47 is calculated, for example, on the basis of the product of the height of the protruding portions 46 in the axial direction, as seen in the radial direction, and the interval between adjacent ones of the protruding portions 46 in the radial direction. This ensures the flow performance of the oil pressure and also reduces a clearance between the piston 40 and the sleeve portion 22a in a region where a flow area is unnecessary, thereby making it possible that the hydraulic oil receives more resistance in the circumferential direction. Although in this example the cross-sectional area of the flow passages 47 is set equal to the cross-sectional area of the supply holes 22c, this is not restrictive. For example, the cross-sectional area of the flow passages 47 may be set greater than the cross-sectional area of the supply holes 22c. This alternative improves the flow performance of oil pressure, thus curbing an increase in pressure loss of the oil pressure supplied to the hydraulic oil chamber 50 through the supply holes 22c.

As illustrated in FIG. 5B, the flow passages 47 are equal in number to the supply holes 22c. This allows the oil pressure to be supplied to the hydraulic oil chamber 50 through all the supply holes 22c, thus curbing an increase in pressure loss. In particular, since each of the protruding portions 46 has two agitation faces 46a, the number of the agitation faces 46a is greater than the number of the supply holes 22c. This increases the flow rate of hydraulic oil to be agitated or dammed relative to the hydraulic oil in the hydraulic oil chamber 50, thus reducing the rotational speed difference between the hydraulic oil and the hydraulic oil chamber 50.

Further, the length of the protruding portions 46 in the circumferential direction is greater than the length of the flow passages 47 in the circumferential direction. In other words, in the circumferential direction around the axial direction, the length of the protruding portions 46 in the circumferential direction is greater than the interval between the protruding portions 46 that are adjacent to each other in the circumferential direction. Further, the length of the agitation faces 46a in the radial direction is less than the length of the protruding portions 46 in the circumferential direction. This increases the area of abutment between the protruding portions 46 and the flange portion 22b of the oil chamber defining portion 22, thus agitating or damming the hydraulic oil in the hydraulic oil chamber 50 more effectively so that the circumferential speed of the hydraulic oil becomes closer to the circumferential speed of the piston 40 and the oil chamber defining portion 22.

Next, the operation of the second clutch C2 is described. When the internal combustion engine is running, the second clutch C2 is rotating, and the piston 40 is stopped in the axial direction, oil pressure in each of the hydraulic oil chamber 50 and the cancel oil chamber 51 becomes higher on the outer peripheral side, i.e., centrifugal oil pressures are generated. In this case, the centrifugal oil pressures in the hydraulic oil chamber 50 and the cancel oil chamber 51 face each other across the piston 40 and thus cancel each other out.

For example, When the second clutch C2 transitions from an disengaged state to an engaged state, oil pressure is supplied to the hydraulic, oil chamber 50 from the communication hole 11a in the input shaft 11 via the supply holes 22c and the flow passages 47. At this time, since the oil pressure is supplied from the supply holes 22c to the flow passages 47 that face the supply holes 22c, the protruding portions 46 avoid blocking a passage where the oil pressure flows so as not to cause an increase in pressure loss.

It is noted that although the rotational speed of the hydraulic oil in the hydraulic oil chamber 50 becomes less than the rotational speed of the piston 40 and the oil chamber defining portion 22 due to hydraulic oil supplied thereto from outside, the agitation faces 46a agitate the hydraulic oil so that the rotational speed of the hydraulic oil becomes sufficiently close to the rotational speed of the piston 40 and the oil chamber defining portion 22. This reduces the rotational speed difference between the hydraulic oil and the hydraulic oil chamber 50 even during an engagement transition of the clutch C2, thus generating centrifugal oil pressure equivalent to that in the cancel oil chamber 51, improving the responsiveness of engagement operation, and achieving satisfactory controllability.

Further, for example, when the second clutch C2 transitions from the engaged state to the disengaged state, the supply of oil pressure is stopped so that the piston 40 is slid rearward by the return spring 27. At this time, although the rotational speed of the hydraulic oil in the hydraulic oil chamber 50 becomes greater than the rotational speed of the piston 40 and the oil chamber defining portion 22, the agitation faces 46a abut and dam the hydraulic oil so that the rotational speed of the hydraulic oil becomes sufficiently close to the rotational speed of the piston 40 and the oil chamber defining portion 22. This reduces the rotational speed difference between the hydraulic oil and the hydraulic oil chamber 50 even during a disengagement transition of the second clutch C2, thus generating centrifugal oil pressure equivalent to that in the cancel oil chamber 51, improving the responsiveness of engagement operation, and achieving satisfactory controllability.

As already described, the second clutch C2 according to the present embodiment has the agitation faces 46a that extend in the direction crossing the circumferential direction. Thus, the hydraulic oil in the hydraulic oil chamber 50 is agitated or dammed by the agitation faces 46a during rotation of the piston 40 and the oil chamber defining portion 22 so that the rotational speed of the hydraulic oil becomes close to the rotational speed of the piston 40 and the oil chamber defining portion 22. This reduces the rotational speed difference between the hydraulic oil and the hydraulic oil chamber 50 even during a transition between engagement and disengagement of the clutch C2, thus stabilizing the cancel performance, improving the responsiveness, and achieving satisfactory controllability.

Further, in the second clutch C2 according to the present embodiment, when the capacity of the hydraulic oil chamber 50 is minimized, the supply holes 22c in the oil chamber defining portion 22 face the flow passages 47 in the radial direction. Thus, when oil pressure is supplied to the hydraulic oil Chamber 50 through the supply holes 22c in a situation where the capacity of the hydraulic oil chamber 50 is minimized, the oil pressure is supplied from the supply holes 22c to the flow passages 47 that face the supply holes 22c. Thus, the protruding portions 46 avoid blocking a passage where the oil pressure flows so as to ensure the flow performance of the oil pressure. This improves the responsiveness of the second clutch C2 and reduces the pressure loss.

Further, in the power transmission device 1 according to the present embodiment, the input shaft 11 has the communication hole 11a for supplying hydraulic oil to the supply holes 22c in the oil chamber defining portion 22, and the second clutch C2 starts being supplied with the hydraulic oil so as to get engaged while the oil chamber defining portion 22 and the piston 40 rotate faster than the input shaft 11. Since the member that rotates faster than the input shaft 11 having the communication hole 11a is provided with the protruding portions 46, it is possible for the agitation faces 46a to agitate the hydraulic oil supplied to the flow passages 47 from the communication hole 11a that rotates slowly.

Further, in the power transmission device 1 according to the present embodiment, the oil chamber defining portion 22 and the piston 40 of the second clutch C2 are formed to one of the rotating elements that rotates when a predetermined forward shift speed is established, and the one of the rotating elements rotates faster than any other of the rotating elements. Specifically, as illustrated in FIG. 3, the oil chamber defining portion 22 and the piston 40 of the second clutch C2 are formed to one of the rotating elements that rotate, for example, when forward shift speeds except the forward fourth speed are established, and the one of the rotating elements rotates faster than any other of the rotating elements. Thus, since the clutch device according to the present embodiment is used as the second clutch C2 that has a large rotation difference relative to the input shaft 11 provided with the communication hole 11a, it is possible for the agitation faces 46a to agitate the hydraulic oil that is supplied from the communication hole 11a rotating at low speed to the flow passage 47 rotating at the fastest speed.

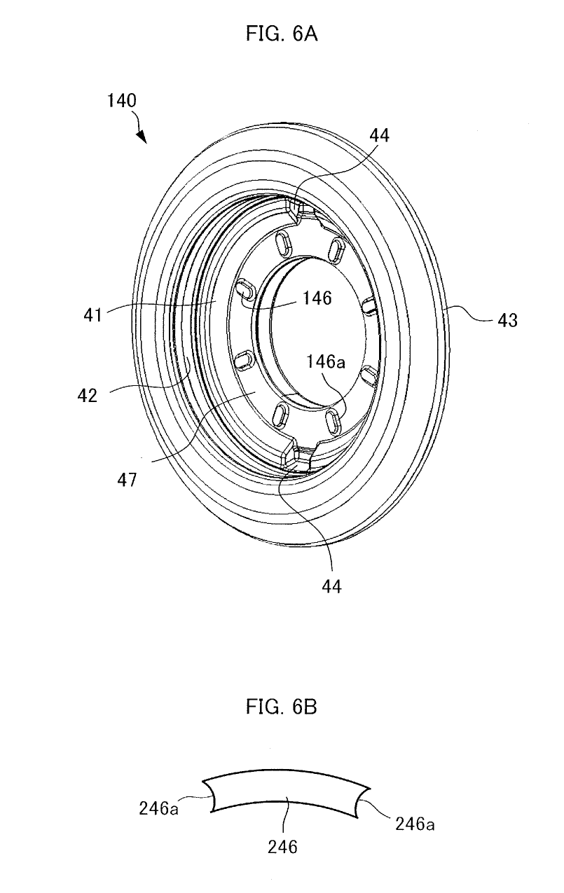

Although the second clutch C2 according to the present embodiment is illustrated such that the length of the agitation faces 46a in the radial direction is less than the length of the protruding portions 46 in the circumferential direction, this is illustrative only. For example, as illustrated in FIG. 6A, the length of agitation faces 146a in the radial direction may be greater than the length of protruding portions 146 in the circumferential direction. This approach reduces the area of abutment between the flange portion 22b of the oil chamber defining portion 22 and the protruding portions 146, thus making it less likely that the protruding portions 146 get stuck to the flange portion 22b.

Although the second clutch C2 according to the present embodiment is illustrated such that the agitation faces 46a have a flat surface, this is illustrative only. For example, as illustrated in FIG. 6B, agitation faces 246a of protruding portions 246 may have a concave surface, a wavy surface, a stepped surface, or the like. Any of these approaches allows the agitation faces 246a to agitate or darn the hydraulic oil in the hydraulic oil chamber 50 more effectively during rotation of the piston 40 and the oil chamber defining portion 22.

Although the second clutch C2 according to the present embodiment is illustrated such that only the piston 40 has the protruding portions 46, this is illustrative only. For example, the piston 40 may have no protruding portions while the oil chamber defining portion 22 may have protruding portions. Alternatively, both the piston 40 and the oil chamber defining portion 22 may have protruding portions. In the case where the piston 40 has no protruding portions while the oil chamber defining portion 22 has protruding portions, the time when the capacity of the hydraulic oil chamber 50 is minimized is the time when the protruding portions 46 abut against the other of facing portions, i.e., the piston 40. Alternatively, in the case where both the piston 40 and the oil chamber defining portion 22 have protruding portions, the protruding portions of the piston 40 may mate with the protruding portions of the oil chamber defining portion 22. This increases design flexibility.

Although the second clutch C2 according to the present embodiment illustrated such that the protruding portions 46 protrude inside the hydraulic oil chamber 50, this is illustrative only. For example, protruding portions may protrude inside the cancel oil chamber 51 as well as inside the hydraulic oil chamber 50. Specifically, in addition to the protruding portions 46 protruding into the hydraulic oil chamber 50, at least one of a facing portion of the cancel plate portion 23 and a facing portion of the piston 40 may be provided with protruding portions that protrude toward the other of the facing portions and that have an agitation face on the side surface thereof to agitate or dam hydraulic oil. In this case, the hydraulic oil in the cancel oil chamber 51 is agitated or dammed during rotation of the piston 40 and the cancel plate portion 23 so that the circumferential speed of the hydraulic oil becomes more equal to the circumferential speed of the piston 40 and the cancel plate portion 23. This reduces the rotational speed difference between the hydraulic oil and each of the hydraulic oil chamber 50 and the cancel oil chamber 51, thus more effectively stabilizing the cancel performance, improving the responsiveness, and achieving more satisfactory controllability.

The present embodiment includes at least the following structures. A clutch device (C2) according to the present embodiment includes: a hydraulic servo (20) including a piston (40, 140), an oil chamber defining portion (22) that rotates along with the piston (40, 140), that supports the piston (40, 140) movably in an axial direction, and that forms together with the piston (40, 140) a variable capacity hydraulic oil chamber (50) therebetween, and a cancel plate (23) that faces the oil chamber defining portion (22) across the piston (40, 140) in the axial direction and that forms together with the piston (40, 140) a variable capacity cancel oil chamber (51) therebetween; multiple friction plates (30, 31) to be engaged by being pressed by the piston (40, 140) that moves in the axial direction in accordance with hydraulic oil supplied to the hydraulic oil chamber (50); and protruding portions (46, 146, 246) that are formed at at least one (41) of friction portions (41, 22b) of the oil chamber defining portion (22) and the piston (40, 140) and that protrude in the axial direction toward the other (22b) of the facing portions (41, 22b), in which the protruding portions (46, 146, 246) have an agitation face (46a, 146a, 246a) on a side surface thereof to agitate or darn the hydraulic oil, the oil chamber defining portion (22) has a supply hole (22c) that is allowed to supply the hydraulic oil from outside the hydraulic oil chamber (50) by communicating with the hydraulic oil chamber (50) from the rotational center side, and when the protruding portions (46, 146, 246) abut against the other (22) of the facing portions so that the capacity of the hydraulic oil chamber (50) is minimized, the supply hole (22c) faces, in a radial direction, a flow passage (47) that is surrounded by circumferentially adjacent ones of the protruding portions (46, 146, 246) and the facing portions (41, 22b). Since this structure has the agitation face (46a, 146a, 246a) for agitating or damming the hydraulic oil, the hydraulic oil in the hydraulic oil chamber (50) is agitated or dammed by the agitation face (46a, 146a, 246a) during rotation of the piston (40, 140) and the oil chamber defining portion (22) so that the circumferential speed of the hydraulic oil becomes equal to the circumferential speed of the piston (40, 140) and the oil chamber defining portion (22). This reduces the circumferential speed difference between the hydraulic oil and the hydraulic oil chamber (50) even during a transition between engagement and disengagement of the clutch device (C2), thus stabilizing the cancel performance, improving the responsiveness, and achieving satisfactory controllability. Further, when oil pressure is supplied to the hydraulic oil chamber (50) through the supply hole (22c) in a situation where the capacity of the hydraulic oil chamber (50) is minimized, the oil pressure is supplied from the supply hole (22c) to the flow passage (47) that faces the supply hole (22c). Thus, the protruding portions (46, 146, 246) avoid blocking a passage where the oil pressure flows so as to ensure the flow performance of the oil pressure. This improves the responsiveness of the clutch device (C2) and reduces the pressure loss.

Further, a clutch device (C2) according to the present embodiment includes: a hydraulic servo (20) including a piston (40, 140), an oil chamber defining portion (22) that rotates along with the piston (40, 140), that supports the piston (40, 140) movably in an axial direction, and that forms together with the piston (40, 140) a variable capacity hydraulic oil chamber (50) therebetween, and a cancel plate (23) that faces the oil chamber defining portion (22) across the piston (40, 140) in the axial direction and. that forms together with the piston (40, 140) a variable capacity cancel oil chamber (51) therebetween; multiple friction plates (30, 31) to be engaged by being pressed by the piston (40, 140) that moves in the axial direction in accordance with hydraulic oil supplied to the hydraulic oil chamber (50); and protruding portions (46, 146, 246) that are formed at at least one (41) of facing portions (41, 22b) of the oil chamber defining portion (22) and the piston (40, 140) and that protrude in the axial direction toward the other (22b) of the facing portions (41, 22b), in which the protruding portions (46, 146, 246) have an agitation face (46a, 146a, 246a) on a side surface thereof to agitate or dam the hydraulic oil, and the agitation face (46a, 146a, 246a) has a flat or concave surface extending in a direction crossing a circumferential direction. This structure allows the agitation face (46a, 146a, 246a) to agitate or darn the hydraulic oil in the hydraulic oil chamber (50) more effectively during rotation of the piston (40, 140) and the oil chamber defining portion (22).

Further, in the clutch device (C2) according to the present embodiment, the cross-sectional area of the flow passage (47) that is calculated from the product of the height of the protruding portions (46, 146, 246) in the axial direction, as seen in a radial direction, and the interval between the adjacent ones of the protruding portions (46, 146, 246) in the radial direction is greater than the cross-sectional area of the supply hole (22c). This structure ensures the flow performance of the oil pressure, thus improving the responsiveness of the clutch device (C2) and reducing the pressure loss.

Further, in the clutch device (C2) according to the present embodiment, the flow passage (47) is equal in number to the supply hole (22c). This structure allows the oil pressure to be supplied to the hydraulic oil chamber (50) through each supply hole (22c), thus improving the flow performance of the oil pressure.

Further, in the clutch device (C2) according to the present embodiment, the agitation face (46a, 146a, 246a) is on a radial line from the center of rotation, In this structure, since the agitation face (46a, 146a, 246a) is perpendicular to the circumferential. direction, the hydraulic oil in the hydraulic oil chamber (50) is agitated or dammed by the agitation face (46a, 146a, 246a) more effectively during rotation of the piston (40, 140) and the oil chamber defining portion (22). Thus, the circumferential speed of the hydraulic oil becomes closer to the circumferential speed of the piston (40, 140) and the oil chamber defining portion (22).

Further, in the clutch device (C2) according to the present embodiment, the length of the protruding portions (46) in the circumferential direction is greater than the interval between the adjacent ones of the protruding portions (46) in the circumferential direction. This structure increases the area of abutment between the oil chamber defining portion (22) and the protruding portions (46), thus agitating or damming the hydraulic oil in the hydraulic oil chamber (50) more effectively so that the circumferential speed of the hydraulic oil becomes closer to the circumferential speed of the piston (40) and the oil chamber defining portion (22).

Further, the clutch device (C2) according to the present embodiment includes a rotation stopper (44, 22d) that is located outside the protruding portions (46, 146, 246) in the radial direction between the facing portions of the oil chamber defining portion (22) and the piston (40, 140) and that prevents relative rotation between the piston (40, 140) and the oil chamber defining portion (22). In this structure, the rotation stopper (44, 22d) prevents the relative rotation between the piston (40, 140) and the oil chamber defining portion (22), thus fixing a relative position between the supply hole (22c) provided in the oil chamber defining portion (22) and the flow passage (47) provided between the protruding portions (46, 146, 246). This makes sure that the oil pressure is supplied from the supply hole (22c) to the flow passage (47) that faces the supply hole (22c). Thus, the protruding portions (46, 146, 246) avoid blocking a passage where the oil pressure flows so as to ensure the flow performance of the oil pressure.

Further, a power transmission device (1) according to the present embodiment includes: an input member (11) to be driven by a drive source; an output member (61); and a speed change mechanism (10) disposed in a power transmission path between the input member (11) and the output member (61) and operable by oil pressure supplied thereto and discharged therefrom to change a speed ratio between the input member (11) and the output member (61), in which the speed change mechanism (10) has multiple friction engagement elements (C1 to C4, B1, B2) including the clutch device (C2) and is operable to establish multiple shift speeds in accordance with simultaneously engaged combinations of the multiple friction engagement elements, the input member (11) has a communication hole (11a) for supplying hydraulic oil to the supply hole (22c) in the oil chamber defining portion (22), and the clutch device (C2) starts being supplied with the hydraulic oil so as to get engaged while the oil chamber defining portion (22) and the piston (40, 140) rotate faster than the input member (11). In this structure, since the member that rotates faster than the input member (11) having the communication hole (11a) is provided with the protruding portions (46, 146, 246), it is possible for the agitation face (46a, 146a, 246a) to agitate the hydraulic oil supplied to the flow passage (47) from the communication hole (11a) that rotates slowly.

Further, a power transmission device (1) according to the present embodiment includes: an input member (11) to be driven by a drive source; an output member (61); and a speed change mechanism (10) disposed in a power transmission path between the input member (11) and the output member (61) and operable by oil pressure supplied thereto and discharged therefrom to change a speed ratio between the input member (11) and the output member (61), in which the speed change mechanism (10) has multiple friction engagement elements (C1 to C4, B1, B2) including the clutch device (C2) and is operable to establish multiple shift speeds in accordance with simultaneously engaged combinations of the multiple friction engagement elements, the input member (11) has a communication hole (11a) for supplying hydraulic oil to the supply hole (22c) in the oil chamber defining portion (22), the oil chamber defining portion (22) and the piston (40, 140) of the clutch device (C2) are formed to one of rotating elements that rotate when a predetermined forward shift speed is established, and the one of the rotating elements rotates faster than any other of the rotating elements. In this structure, the clutch device (C2) is used as the friction engagement element (C2) that has a large rotation difference relative to the input member (11) provided with the communication hole (11a). This allows the agitation face (46a, 146a, 246a) to agitate the hydraulic oil that is supplied from the communication hole (11a) rotating at low speed to the flow passage (47) rotating at the fastest speed.

### EXAMPLE 1

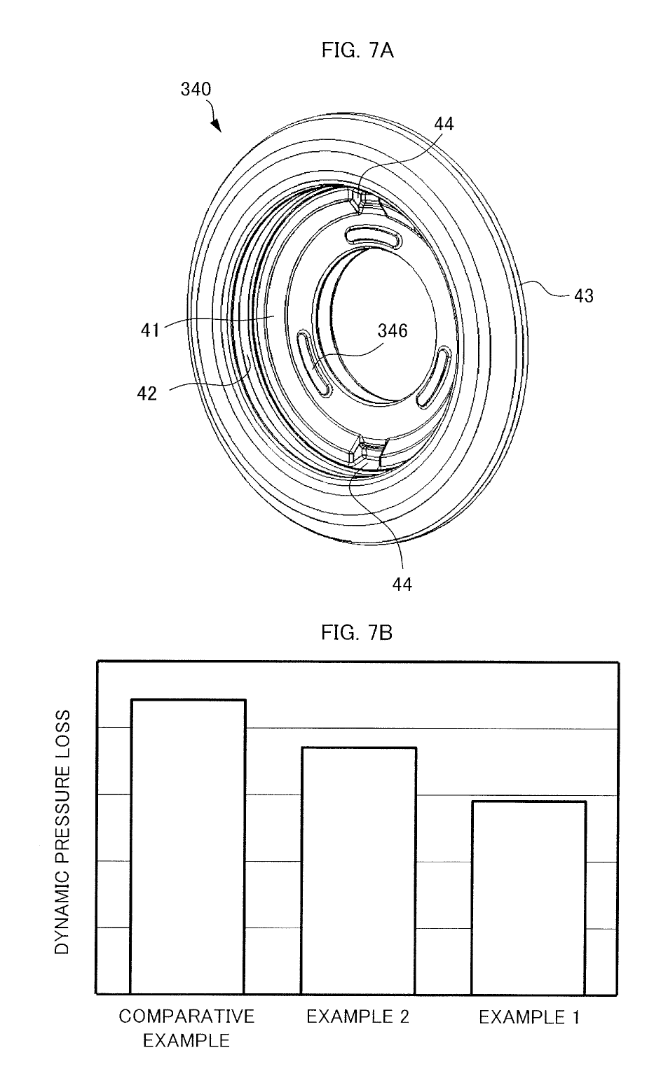

Here, by using the second clutch C2 with the piston 40 according to the embodiment illustrated in FIG. 4, FIG. 5A, and FIG. 5B, dynamic pressure loss was analyzed by supplying oil pressure with a predetermined flow rate under a predetermined rotating speed. FIG. 7B shows the result.

### EXAMPLE 2

Further, by using the second clutch C2 with the piston 140 according to the embodiment illustrated in FIG. 6A, dynamic pressure loss was analyzed in the same manner as in Example 1 by supplying oil pressure with the predetermined flow rate under the predetermined rotating speed. FIG. 7B shows the result.

### COMPARATIVE EXAMPLE

Furthermore, by using the second clutch C2 with a piston 340 according to the related art illustrated in FIG. 7A, dynamic pressure loss was analyzed in the same manner as in Example 1 by supplying oil pressure with the predetermined flow rate under the predetermined rotating speed. It is noted that protruding portions 346 of the piston 340 have no agitation face so as not to agitate or dam hydraulic oil during rotation. FIG. 7B shows the result.

As evidenced by FIG. 7B, Comparative Example had the largest dynamic pressure, and the dynamic pressure losses in Example 1 and Example 2 were smaller than that in Comparative Example. This demonstrates that the second clutch C2 according to the present embodiment has the effect of reducing dynamic pressure.

### INDUSTRIAL APPLICABILITY

The automatic transmission relates to clutch devices suitable for use in vehicle drive devices mounted on vehicles, and, in particular, may be preferably used as clutch devices that are engaged and disengaged by hydraulic oil supplied thereto and discharged therefrom.

### DESCRIPTION OF THE REFERENCE NUMERALS

1: POWER TRANSMISSION DEVICE

10: AUTOMATIC TRANSMISSION (SPEED CHANGE MECHANISM)

11: INPUT SHAFT (INPUT MEMBER)

11a: COMMUNICATION HOLE

20: HYDRAULIC SERVO

22: OIL CHAMBER DEFINING PORTION (THE OTHER OF FACING PORTIONS)

22c: SUPPLY HOLE

22d: PROJECTION (ROTATION STOPPER)

23: CANCEL PLATE PORTION

30: INNER FRICTION PLATE (A PLURALITY OF FICTION PLATES)

31: OUTER FRICTION PLATE (A PLURALITY OF FICTION PLATES)

40: PISTON (THE OTHER OF FACING PORTIONS)

41: PRESSURE RECEIVING PORTION (ONE OF FACING PORTIONS)

44: RECESS (ROTATION STOPPER)

46: PROTRUDING PORTION

46a: AGITATION FACE

47: FLOW PASSAGE

50: HYDRAULIC OIL CHAMBER

51: CANCEL OIL CHAMBER

61: OUTPUT SHAFT (OUTPUT MEMBER)

140: PISTON

146: PROTRUDING PORTION

146a: AGITATION FACE

246: PROTRUDING PORTION

246a: AGITATION FACE

C2: SECOND CLUTCH (CLUTCH DEVICE)

1-9. (canceled)

10. A clutch device comprising:
a hydraulic servo including a piston, an oil chamber defining portion that rotates along with the piston, that supports the piston movably in an axial direction, and that forms together with the piston a variable capacity hydraulic oil chamber between the piston and the oil chamber defining portion, and a cancel plate portion that faces the oil chamber defining portion across the piston in the axial direction and that forms together with the piston a variable capacity cancel oil chamber between the piston and the cancel plate portion;
a plurality of friction plates to be engaged by being pressed by the piston that moves in the axial direction in accordance with hydraulic oil supplied to the hydraulic oil chamber; and
protruding portions that are formed at at least one of a facing portion of the oil chamber defining portion and a facing portion of the piston and that protrude in the axial direction toward the other of the facing portions, wherein
the protruding portions have an agitation face on its side surface to agitate or dam the hydraulic oil,
the oil chamber defining portion has a supply hole that is allowed to supply the hydraulic oil from outside the hydraulic oil chamber by communicating with the hydraulic oil chamber from a rotational center side, and
when the protruding portions abut against the other of the facing portions so that a capacity of the hydraulic oil chamber is minimized, the supply hole faces, in a radial direction, a flow passage that is surrounded by circumferentially adjacent ones of the protruding portions and the facing portions.

11. The clutch device according to claim 10, wherein
a cross-sectional area of the flow passage that is calculated from a product of a height of the protruding portions in the axial direction, as seen in a radial direction, and an interval between the adjacent ones of the protruding portions in the radial direction is greater than a cross-sectional area of the supply hole.

12. The clutch device according to claim 11, wherein
the flow passage is equal in number to the supply hole.

13. The clutch device according to claim 12, wherein
the agitation face is on a radial line from a center of rotation.

14. The clutch device according to claim 13, wherein
a length of the protruding portions in the circumferential direction is greater than an interval between adjacent ones of the protruding portions in the circumferential direction.

15. The clutch device according to claim 14, further comprising:
a rotation stopper that is located outside the protruding portions in the radial direction between the facing portions of the oil chamber defining portion and the piston and that does not allow relative rotation between the piston and the oil chamber defining portion.

16. A power transmission device comprising:
an input member to be driven by a drive source;
an output member; and
a speed change mechanism disposed in a power transmission path between the input member and the output member and operable by oil pressure supplied to and discharged from the speed change mechanism to change a speed ratio between the input member and the output member, wherein
the speed change mechanism has a plurality of friction engagement elements including the clutch device of claim 15 and is operable to establish a plurality of shift speeds in accordance with simultaneously engaged combinations of the plurality of friction engagement elements,
the input member has a communication hole for supplying hydraulic oil to the supply hole in the oil chamber defining portion, and
the clutch device starts being supplied with the hydraulic oil so as to get engaged while the oil chamber defining portion and the piston rotate faster than the input member.

17. A power transmission device comprising:
an input member to be driven by a drive source;
an output member; and
a speed change mechanism disposed in a power transmission path between the input member and the output member and operable by oil pressure supplied to and discharged from the speed change mechanism to change a speed ratio between the input member and the output member, wherein
the speed change mechanism has a plurality of friction engagement elements including the clutch device of claim 15 and is operable to establish a plurality of shift speeds in accordance with simultaneously engaged combinations of the plurality of friction engagement elements,
the input member has a communication hole for supplying hydraulic oil to the supply hole in the oil chamber defining portion,
the oil chamber defining portion and the piston of the clutch device are formed to one of rotating elements that rotates when a predetermined forward shift speed is established, and
the one of the rotating elements rotates faster than any other of the rotating elements.

18. The clutch device according to claim 10, wherein
the flow passage is equal in number to the supply hole.

19. The clutch device according to claim 10, wherein
the agitation face is on a radial line from a center of rotation.

20. The clutch device according to claim 10, wherein
a length of the protruding portions in the circumferential direction is greater than an interval between adjacent ones of the protruding portions in the circumferential direction.

21. The clutch device according to claim 10, further comprising:
a rotation stopper that is located outside the protruding portions in the radial direction between the facing portions of the oil chamber defining portion and the piston and that does not allow relative rotation between the piston and the oil chamber defining portion.

22. A power transmission device comprising:
an input member to be driven by a drive source;
an output member; and
a speed change mechanism disposed in a power transmission path between the input member and the output member and operable by oil pressure supplied to and discharged from the speed change mechanism to change a speed ratio between the input member and the output member, wherein
the speed change mechanism has a plurality of friction engagement elements including the clutch device of claim 10 and is operable to establish a plurality of shift speeds in accordance with simultaneously engaged combinations of the plurality of friction engagement elements,
the input member has a communication hole for supplying hydraulic oil to the supply hole in the oil chamber defining portion, and
the clutch device starts being supplied with the hydraulic oil so as to get engaged while the oil chamber defining portion and the piston rotate faster than the input member.

23. A power transmission device comprising:
an input member to be driven by a drive source;
an output member; and
a speed change mechanism disposed in a power transmission path between the input member and the output member and operable by oil pressure supplied to and discharged from the speed change mechanism to change a speed ratio between the input member and the output member, wherein
the speed change mechanism has a plurality of friction engagement elements including the clutch device of claim 10 and is operable to establish a plurality of shift speeds in accordance with simultaneously engaged combinations of the plurality of friction engagement elements,
the input member has a communication hole for supplying hydraulic oil to the supply hole in the oil chamber defining portion,
the oil chamber defining portion and the piston of the clutch device are formed to one of rotating elements that rotates when a predetermined forward shift speed is established, and
the one of the rotating elements rotates faster than any other of the rotating elements.

24. A clutch device comprising:
a hydraulic servo including a piston, an oil chamber defining portion that rotates along with the piston, that supports the piston movably in an axial direction, and that forms together with the piston a variable capacity hydraulic oil chamber between the piston and the oil chamber defining portion, and a cancel plate portion that faces the oil chamber defining portion across the piston in the axial direction and that forms together with the piston a variable capacity cancel oil chamber between the piston and the cancel plate portion;
a plurality of friction plates to be engaged by being pressed by the piston that moves in the axial direction in accordance with hydraulic oil supplied to the hydraulic oil chamber; and
protruding portions that are formed at at least one of a facing portion of the oil chamber defining portion and a facing portion of the piston and that protrude in the axial direction toward the other of the facing portions, wherein
the protruding portions have an agitation face on its side surface to agitate or dam the hydraulic oil, and
the agitation face has a flat or concave surface extending in a direction crossing a circumferential direction.

25. The clutch device according to claim 24, wherein
the agitation face is on a radial line from a center of rotation.

26. The clutch device according to claim 25, wherein
a length of the protruding portions in the circumferential direction is greater than an interval between adjacent ones of the protruding portions in the circumferential direction.

27. The clutch device according to claim 26, further comprising:
a rotation stopper that is located outside the protruding portions in the radial direction between the facing portions of the oil chamber defining portion and the piston and that does not allow relative rotation between the piston and the oil chamber defining portion.

28. A power transmission device comprising:
an input member to be driven by a drive source;
an output member; and
a speed change mechanism disposed in a power transmission path between the input member and the output member and operable by oil pressure supplied to and discharged from the speed change mechanism to change a speed ratio between the input member and the output member, wherein
the speed change mechanism has a plurality of friction engagement elements including the clutch device of claim 27 and is operable to establish a plurality of shift speeds in accordance with simultaneously engaged combinations of the plurality of friction engagement elements,
the input member has a communication hole for supplying hydraulic oil to a supply hole in the oil chamber defining portion, and
the clutch device starts being supplied with the hydraulic oil so as to get engaged while the oil chamber defining portion and the piston rotate faster than the input member.

29. A power transmission device comprising:
an input member to be driven by a drive source;
an output member; and
a speed change mechanism disposed in a power transmission path between the input member and the output member and operable by oil pressure supplied to and discharged from the speed change mechanism to change a speed ratio between the input member and the output member, wherein
the speed change mechanism has a plurality of friction engagement elements including the clutch device of claim 27 and is operable to establish a plurality of shift speeds in accordance with simultaneously engaged combinations of the plurality of friction engagement elements,
the input member has a communication hole for supplying hydraulic oil to the supply hole in the oil chamber defining portion,
the oil chamber defining portion and the piston of the clutch device are formed to one of rotating elements that rotates when a predetermined forward shift speed is established, and
the one of the rotating elements rotates faster than any other of the rotating elements.
